(19) United States
(12) Patent Application Publication
(10) Pub. No.: US 2016/0042441 A1
(43) Pub. Date: Feb. 11, 2016

(54) SHOP SYSTEM

(71) Applicant: CROSS DREAM CO., LTD., Tokyo (JP)

(72) Inventors: TSUTOMU TAJIRI, Tokyo (JP); Hiroshi FUKUMA, Tokyo (JP)

(73) Assignee: CROSS DREAM CO., LTD., Tokyo (JP)

(21) Appl. No.: 14/919,236

(22) Filed: Oct. 21, 2015

Related U.S. Application Data
(63) Continuation-in-part of application No. PCT/JP2014/061219, filed on Apr. 22, 2014.

(30) Foreign Application Priority Data
Apr. 22, 2013 (JP) 2013089299

(51) Int. Cl. G06Q 30/06; G06Q 20/28; G06Q 20/40; G06Q 20/24

(52) U.S. Cl. CPC G06Q 30/0637; G06Q 20/24; G06Q 20/28; G06Q 20/405

(57) ABSTRACT

In order to simplify and facilitate tasks pertaining to orders from customers and to improve customer satisfaction, the present invention includes a main system and a shop system, the shop system including a shop terminal, a kitchen terminal and the like, and various terminals having various functions. The terminals of the shop system can receive orders directly transmitted from terminals of the shop and from other terminals. Further, customers can provide goods to other customers visiting the shop without directly visiting the shop. Further, the shop system allows payment via various settlement means.

### RELATED APPLICATIONS

This application is a continuation-in-part application of, and claims priority to, PCT application number PCT/JP2014/061219 filed Apr. 22, 2014 (International Publication number WO2014/175236), which claims priority to JP Patent Application 2013-089299 filed Apr. 22, 2013, all of which are hereby incorporated by reference.

### TECHNICAL FIELD

The present invention relates to a shop system, and a control method for a shop system, a program and a storage medium for a shop system, and particularly, for desired orders from menus at a shop in the restaurant business.

### BACKGROUND ART

In the shop business, it is essential to take a desired order from a customer, serve the order without errors, and settle a bill correctly. Conventionally, these tasks are performed through manual labor.

In view of the above, there is a demand to achieve flawless operation by computerizing orders and bill settlement.

Further, due to recent fast-paced technological innovation, other than using a computerized, dedicated shop terminal that does not require conventional manual labor, there is a demand for newly developed service that enables acquisition of information on each shop through a personal terminal such as a cellphone via a network. Specifically, as for ordering tasks in restaurant business and the like, terminal devices are provided for each place in a manner such that order information can be gathered through these devices, which results in less workload at the shop side and improvement in customer satisfaction. For example, Japanese Patent Laid-Open No. 2004-302852 discloses a technological concept for receiving reservation and orders from customers. However, under such a technological concept, an order is first received by a server at a shop side, and then information on the order is separately conveyed to a kitchen side.

Patent Document 1: Japanese Patent Laid-Open No. 2004-302582

### SUMMARY OF INVENTION

### Technical Problem

In order to solve the problem above, an object of the present invention is to provide a shop system, a control method for a shop system, a program and a storage medium for a shop system so as to further simplify and facilitate tasks pertaining to orders from customers at any place and to improve customer satisfaction.

### Solution to Problem

In order to solve the problem above,

settlement means for processing settlement at the shop system by cash or equivalent values,

deferred credit payment means, and

adding means for adding up the money amount of the settlement means and the money amount of the deferred credit payment means are provided.

Further,

means for enabling advance payment as a method of payment is further provided.

Further,

means for converting values pertaining to information owned by a customer into a source asset for settlement is further provided.

Further,

means for directly sending and receiving information pertaining to orders from a terminal different from each terminal included in the main system and the shop system to the terminal included in the main system and the shop system is further provided.

Further,

means for processing information for determining whether an order is accepted based on a rank of a customer is further provided.

Further,

means for directly ordering and processing payment without a visit at a shop is further provided.

Further,

means for processing authorization and un-authorization of an order pertaining to a group to which a customer directly ordering without a visit at the shop belongs and a group to which a customer receiving an order belongs is further provided.

More specifically, in an embodiment of the present invention, provided are the main system and the shop system, the shop system including a shop terminal, a POS system and each terminal having various functions, each terminal including a controller, an output unit, an input unit, an interface unit, and means for directly sending and receiving an order from a terminal different from each terminal included in the shop system to the terminal included in the shop system.

In another embodiment of the present invention, in the description above, means for determining whether an order is accepted based on a rank of a customer is further provided. In this case, means for processing information may target external information to be processed.

### Advantageous Effects of Invention

According to the present invention, customers can send an order directly to a kitchen, and the ordering task from receiving an order to placing an order at the kitchen can be streamlined, which results in more convenience. Further, such a system is more convenient for a service recipient as he or she can enjoy the service simply by accessing a service site. Further, such a system can provide quality service as to customer orders and payment.

### BRIEF DESCRIPTION OF DRAWING

FIG. 1 is a general block diagram according to an embodiment of the present invention.

FIG. 2 is a block diagram of a shop system according to an embodiment of the present invention.

FIG. 3 is a schematic diagram of a terminal according to an embodiment of the present invention.

FIG. 4 is a menu screen according to an embodiment of the present invention.

FIG. 5 is a customer classification list according to the present invention.

FIG. 6 is a flow chart of a process for receiving an order from a mobile terminal according to the present invention.

FIG. 7 is a gift group recognition data table according to the present invention.

FIG. 8 is a configuration diagram of a POS system 232 according to an embodiment of the present invention.

FIG. 9 is a configuration diagram of a POS output unit 2323 according to an embodiment of the present invention.

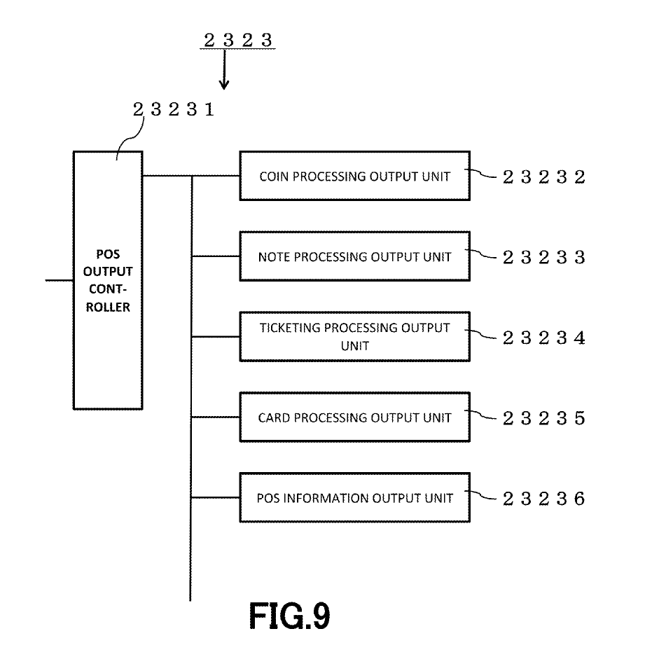

FIG. 10 is a configuration diagram of a POS input unit 2324 according to an embodiment of the present invention.

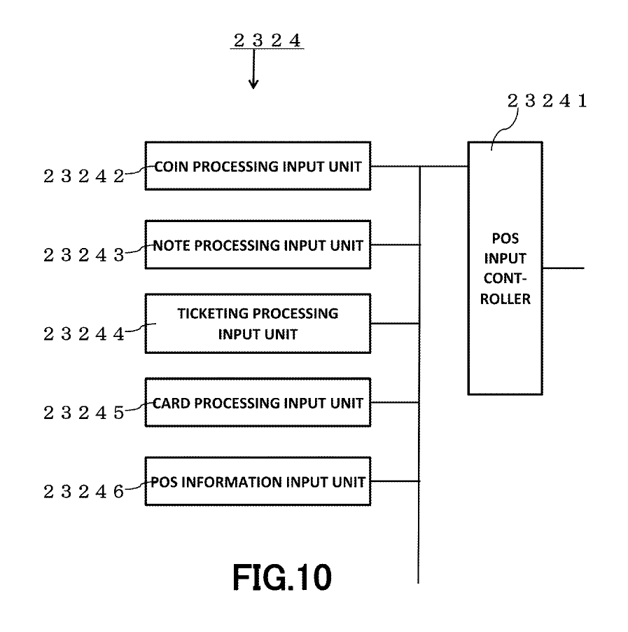

FIG. 11 is an order list data table according to an embodiment of the present invention.

FIG. 12 is a settlement list data table according to an embodiment of the present invention.

FIG. 13 is a schematic diagram of an information value conversion according to an embodiment of the present invention.

### DESCRIPTION OF EMBODIMENTS

The following describes an embodiment of the present invention with reference to the drawings.

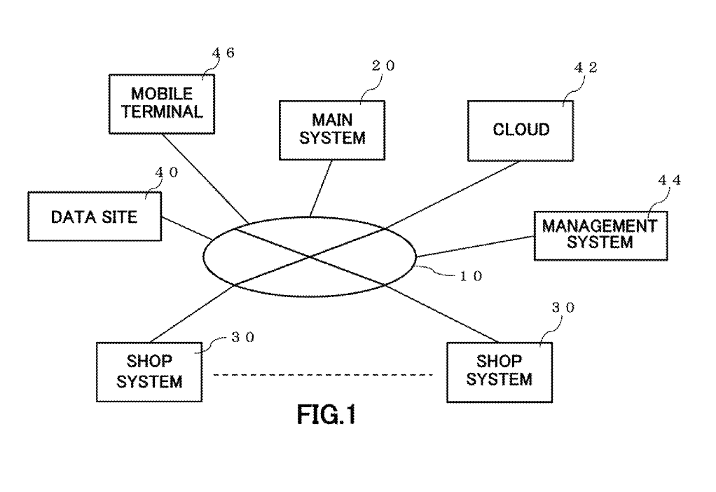

FIG. 1 is a general block diagram according to an embodiment of the present invention. The present system includes a network 10, a main system 20, a shop system 30, a data site 40, and, for example, a mobile terminal 46 that is different from terminals included in the main system or the shop system.

The network 10 realizes an information exchange function among the main system 20, the shop system 30, the data site 40, and the mobile terminal 46. The actual means for the information exchange can be any means and not limited to wired, wireless, or optical communication. The mobile terminal can be, for example, a smartphone, a tablet terminal, or any terminal with equivalent functions.

The main system 20 stores therein information on sales results of each individual shop gathered by the shop system 30 and sends information to any individual shop as needed. The information on sales results of each individual shop may be stored in a management system (server) 44 or a cloud 42 via the network 10.

The shop system 30 manages information on shops and sends information such as sales results of shops to the main system 20 via the network 10. Further, through the mobile terminal 46, a customer directly makes an order to the kitchen of a shop.

The data site 40 processes information exchange among the main system 20, the shop system 30, and other systems, and, for example, may also provide various kinds of processing programs. Further, the data site 40 may be a plurality of sites.

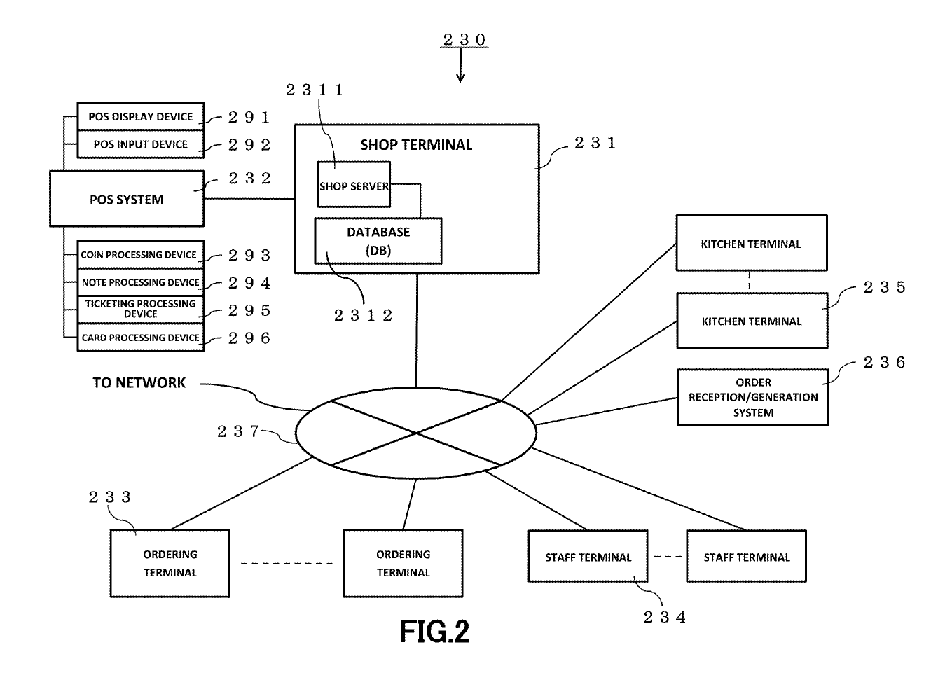

FIG. 2 shows a configuration of the shop system 30. A shop terminal 231 includes a shop server 2311, a database (simply referred to as DB below) 2312, and the like, and is connected to a POS system 232 and further connected to the main system 20 via an in-shop network 237 and the network 10. Further, the POS system 232 is connected to a POS display device 291, a POS input device 292, a coin processing device 293, a note processing device 294, a ticketing processing device 295, a card processing device 296, and the like. Further, the in-shop network 237 is connected to an ordering terminal 233, a staff terminal 234, a kitchen terminal 235, and further connected to an order reception/generation system 236 that manages supplies for tasks of a shop, and to a signage (not shown). The connection may be realized with any means and is not limited to wired, wireless, or optical communication.

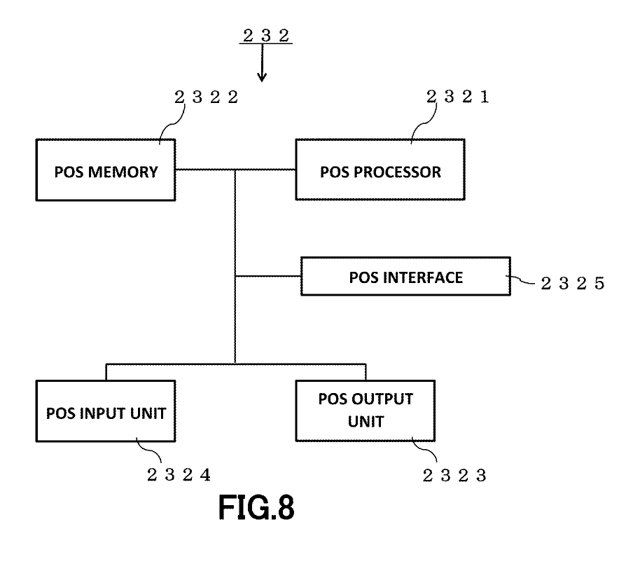

Next, FIG. 8 shows a configuration of the POS system 232. The POS system 232 includes a POS processor 2321, a POS memory 2322, a POS output unit 2323, a POS input unit 2324, a POS interface 2325, and the like. The POS processor 2321 controls the POS system 232, and the POS memory 2322 is used for controlling the POS processor 2321. The POS output unit 2323 is means for output, and the POS input unit 2324 is means for input. These units realize an information output function to the POS processor 2321. Further, the POS system 232 is connected to the shop terminal 231 and the like via the POS interface 2325.

Further, the POS output unit 2323 includes a POS output controller 23231, and further includes a coin processing output unit 23232, a note processing output unit 23233, a ticketing processing output unit 23234, a card processing output unit 23235, a POS information output unit 23236, and the like that are connected thereto. The POS output controller 23231 sends information from the POS processor 2321 to the coin processing output unit 23232, the note processing output unit 23233, the ticketing processing output unit 23234, the card processing output unit 23235, the POS information output unit 23236, and the like.

Further, the POS input unit 2324 includes a POS input controller 23241, and further includes a coin processing input unit 23242, a note processing input unit 23243, a ticketing processing input unit 23244, a card processing input unit 23245, a POS information input unit 23246, and the like that are connected thereto. The POS input controller 23241 sends information from the coin processing input unit 23242, the note processing input unit 23243, the ticketing processing input unit 23244, the card processing input unit 23245, the POS information input unit 23246, and the like to the POS processor 2321.

Further, the coin processing output unit 23232 and the coin processing input unit 23242 control the coin processing device 293; the note processing output unit 23233 and the note processing input unit 23243 control the note processing device 294; the ticketing processing output unit 23234 and the ticketing processing input unit 23244 control the ticketing processing device 295; the card processing output unit 23235 and the card processing input unit 23245 control the card processing device 296; the POS information output unit 23236 controls the POS display device 291; and the POS information input unit 23246 controls the POS input device 292.

The mobile terminal 46, the ordering terminal 233, the staff terminal 234, and the kitchen terminal 235, which are the main parts of the present invention, have the same configuration and the equivalent functions basically. However, appearance, specifically a screen size, may vary depending on a purpose of use thereof. Further, certain specification for each terminal is required in accordance with intended use thereof, and a commercially available generic terminal can be used as long as the specification is met. These terminals overall are referred to below as a terminal 300.

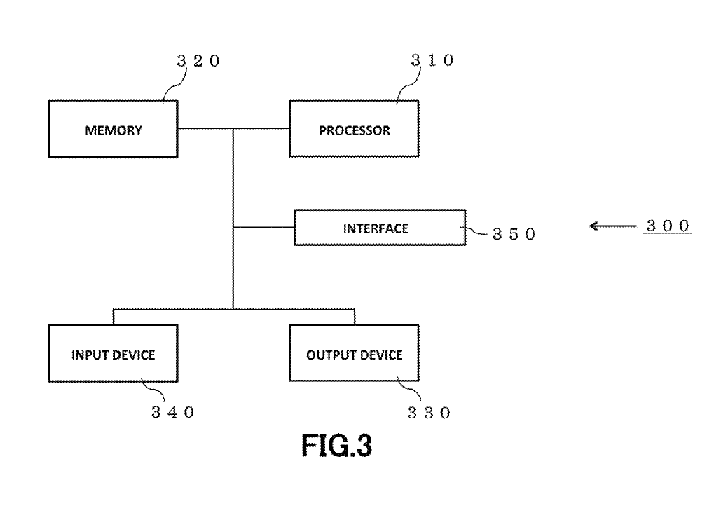

FIG. 3 shows a configuration of the terminal 300. A processor 310 controls the terminal 300, and a memory 320 is used for controlling the processor 310. An input device 340 is means for inputting and an output device 330 realizes a function for displaying information as needed. An interface 350 is connected to the main system 20 via the network 10 and the in-shop network 237.

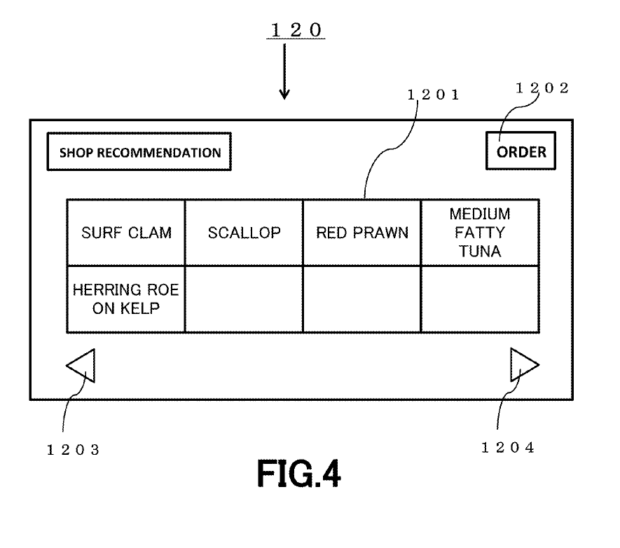

Next, the following describes an example of order through the ordering terminal 233 in accordance with the menu screen in FIG. 4. The ordering terminal 233 is, for example, provided at a table and the like in a restaurant, and is used for taking an order from a customer. As shown in FIG. 4, a menu screen is displayed thereon. A menu screen 120 displays various kinds of menus 1201. When all the menus cannot be displayed in a single screen, the screen may be scrolled by pushing scroll fields 1203 and 1204 so as to display the menus. A menu is selected by pushing a desired menu out of these menus for ordering. At this point, a color of the selected menu may be changed so as to indicate that the menu is ordered. A selection is made by pushing the menu 1201 and an order process for the selected menu is performed by pushing an order field 1202. Instead of the pushdown input above, a touch, a flick, and the like may be adopted, or an order may be automatically processed after a certain period of time without the pushdown input, or eye movement with use of a head mounted display (HMD) may be adopted so as to be recognized in the same manner as the pushdown input. The above is the summary of an order generally performed.

The following describes an embodiment of the present invention. Though an order from a customer is made through the ordering terminal 233 in the description above, an order can be made through the mobile terminal 46 directly to the kitchen terminal 235. Further, for example, a program that enables an order directly to a specific shop via the data site 40 is installed in the mobile terminal 46. A customer can, for example, operate his/her mobile terminal 46 and send an order content to the shop he/she is going to visit. The order content is directly received by the kitchen terminal 235 without passing through the shop terminal 231. The communication therebetween is made via the network 10 and the in-shop network 237. Further, a program that receives an order from the mobile terminal 46 is previously installed in the kitchen terminal 235, and the received order content is displayed in an output device (not shown). In the kitchen, a cook or someone can respond to the content, and furthermore, for example, an order of a menu that is available all the time for order can be automatically accepted and a response can be made to the mobile terminal 46 which made the order. Acceptance of an order is sent to the shop terminal 231 via the in-shop network 237. In this manner, the order is processed in the same way as an ordinary order.

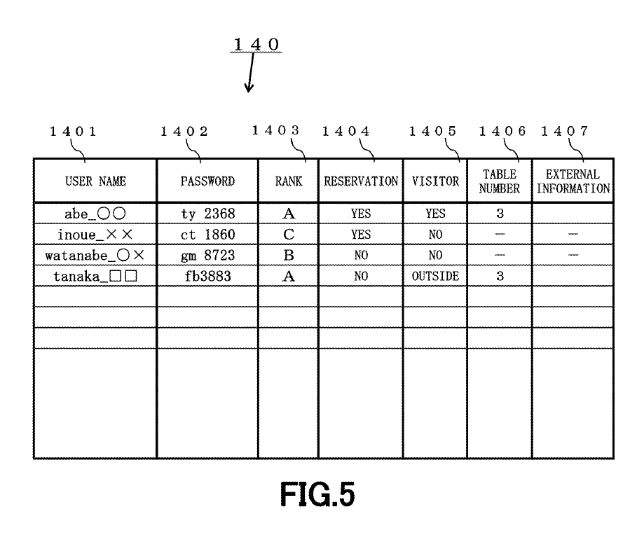

When an order is made through the mobile terminal 46 from a customer as described above and reservation of a table is previously made for the customer, the order is processed in accordance with the reservation. Even when the order is made directly to the kitchen without reservation, the order to the kitchen may also function as reservation as long as there is a vacant table. Further, a number of people for reservation may be estimated based on an order content. Further, if the customer has a record in using service at the shop, a number of people or use of individual space may be automatically estimated based on the record before. Further, there can also be a function that, when seats are fully occupied at the shop, a notification indicating that the seats are full may be sent from the shop terminal 231 to the kitchen terminal 235 via the in-shop network 237 so as to reject incoming orders. Further, as for selection of a customer, the shop terminal 231 and/or the kitchen terminal 235 may include a configuration list to determine how far an order from a customer is to be accepted, or may include information for customer identity verification. For example, there may be a function that a customer selection list 140 shown in FIG. 5 is first checked for a user name and a password with which a direct order to a kitchen is to be approved, and then the order having a higher rank than a customer rank is not accepted based on a result of comparison between the customer rank and the rank of the ordered menu. Further, other means instead of a password may be adopted as long as the means can function as identity verification. The password for identity verification is the same below as the description above.

A case where an order is directly made through a mobile terminal of a customer is described above. The following describes a process for simultaneously using a shop terminal after the customer arrives at the shop and is seated. When a direct order is made through the mobile terminal 46 of a customer and reservation on a table of a shop is accepted or reservation on a table is made prior to the order through the mobile terminal 46 of a customer, information that reservation is accepted is stored. When the customer arrives at the shop, reservation status is checked at the reception. If there is reservation, it is checked that the reservation is ordinary reservation or reservation made through the mobile terminal 46 of the customer. If the reservation is accepted through the mobile terminal 46, information that the customer visits the shop is stored. Further, information such as a number or the like for identifying the table of the customer is stored. In this manner, the order that is made through the mobile terminal 46 of the customer before the customer arrives is associated with the order that is made through the shop terminal. After the customer finishes a meal and settles a bill, sum of the payment for the order made through the customer's mobile terminal 46 and the payment for the order made through the shop terminal is charged.

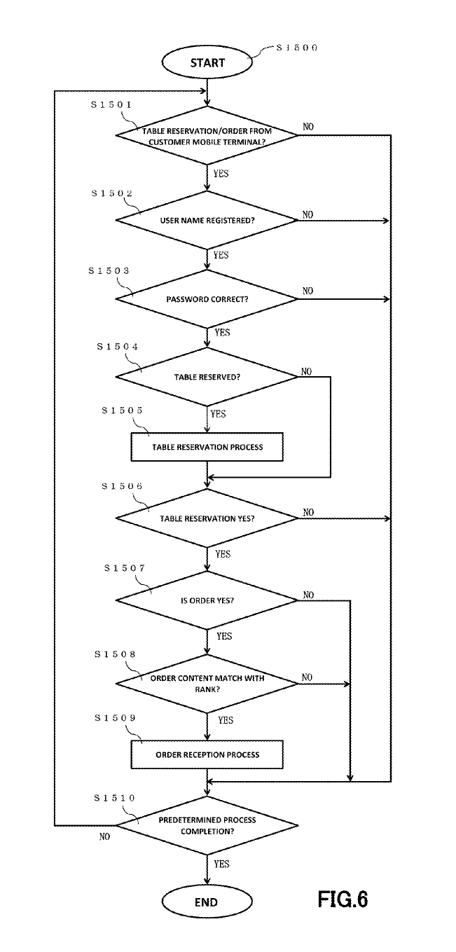

The procedure above is described with reference to FIG. 5 and FIG. 6. The customer selection list 140 is, for example, stored in the memory 230 of the kitchen terminal 235 by the processor 310 of the kitchen terminal 235, and this storage process is processed by the processor 310 of the kitchen terminal 235 according to a program loaded in the memory 320 of the kitchen terminal 235. As long as the same process is provided, the process may be processed by a processor or a memory other than those of the kitchen terminal. When table reservation and/or an order is made to the kitchen terminal 235 through the mobile terminal 46 (S1501), the kitchen terminal 235 checks a user name field 1401 of the customer selection list 140 for a user name of the order (S1502). If the user name is registered, a password and a password field 1302 are checked (S1503). If it is determined that the password is correct, it is checked whether table reservation is needed or not (S1504). If the table reservation is needed, a table reservation process is performed (S1505). When the reservation is successfully made, for example, “YES” is stored in a reservation field 1404. When the reservation cannot be made due to full occupancy of tables, for example, “NO” is stored therein. At this process, an email or the like indicating that the reservation cannot be made may be sent. Next, it is checked whether there is an order (S1507), and if there is an order, the content thereof is checked. Further, a rank is associated with a menu depending on price or the like (not shown), the rank of the menu is compared with a rank field 1403 in order to confirm that the rank of the menu matches with the rank of the customer (S1508). If it is confirmed, an order reception process is performed (S1509). Upon the reception of an order, cooking and the like is processed at the kitchen.

Further, the customer selection list 140 has a visitor field 1405. When reservation of a table and an order for food is made through the mobile terminal 46 of a customer and the customer arrives at the shop, information of this is sent to the kitchen terminal, and, for example, “YES” is stored in the corresponding visitor field 1405, and information for identifying the table, e.g., a table number “3”, is stored in a table number field 1406. After this, when an order process is performed through the ordering terminal 233 in the shop, the order content is sent to the shop system 30 via the in-shop network 237. This information is further sent to the kitchen terminal 235 so as to start the cooking. Further, when an order is made to the kitchen terminal through the mobile terminal 46 after the arrival at the shop and accepted, an order process may be performed in the same way as the ordering terminal. Further, an order through the customer's mobile terminal 46 and an order through the ordering terminal 233 in the shop may be summed up according to the information from the customer selection list 140, and a final settlement process may be performed based on this information. Further, there can be a function that, when the order from the customer through the customer's mobile terminal 46 is completed, for example, “NO” is stored in a reservation field 1404, and other following orders are not accepted. Once a table reservation is accepted again, an order is again accepted. Further, the settlement of an order may be processed, for example, by a credit company that handles settlement of contractual and operating fee of the mobile terminal 46 or an affiliated credit company thereof. Further, information on a customer obtained through a social network or a questionnaire is stored in an external information filed 1407 of the customer selection list 140, whereby external information can be gathered. However, as information about the social network is likely to be updated in a short amount of time, access information that leads to the information source of the customer or a keyword that is used for searching for the customer information may be stored along with the gathered information. Further, collection of information on a customer may be performed not only by referring to the external information field 1407 upon the reservation or order from the customer, but also by searching for a latest external information source with the keyword and the like. Further, even when no reservation or order is made, information search may be regularly performed for information pertaining to the external information field 1407, and the update may be made based on the result of the search. Further, even when a customer is not a regular customer and his/her name is not registered in the customer selection list, information may be stored in the external information field 1407 without setting of a user name and the like if it is determined that the person can be an important potential customer. In such a case, a pen name or a stage name that is usually used by a customer may be registered as a user name. When the customer is registered as a regular customer, information on a user name and a password etc. may be gathered in the same manner as the ordinary case and may be stored in the customer selection list 140.

As described above, the customer's mobile terminal 46 and the in-shop ordering terminal 233 have the same functions, which may be realized by installing a program equivalent to that of the ordering terminal 233 in the customer's mobile terminal 46. In other cases, a simplified program may be installed in the mobile terminal 46, and information required for an order such as a food name, a number, and an amount may be converted into a character string or a code when an order for food is to be made, and the information may be sent, for example, in the form of an email.

An operation of the present system is described above for a case where a customer makes reservation from outside of a shop, and then actually visits the shop, and, for example, has a meal together. Furthermore, for example, even when friends are having meals together in a shop different from the shop the customer visits and the customer intends to order some food as a gift to the friends, the ordering method above is applied.

For example, as shown in FIG. 5, when Mr. “tanaka_□□” does not visit the shop and wants to order wine as a gift at the table number 3, knowing that Mr. “abe_oo” is having a meal, he can instruct a gift, for example, through the mobile terminal 46 in the same manner as the reservation to the shop. Note that a program for instructing a gift is to be previously installed in the same manner as the program for reservation. Upon the gift instruction, similarly to the reservation, a user name “tanaka_□□” and a password “3883” are input. After the identity verification is confirmed (by the system), a button (not shown) for processing a gift is be pushed down through the screen of the mobile terminal 46, and once this is received, information on the destination of the gift such as a name, e.g., “abe_oo” is to be input through the mobile terminal 46 so as to identify a table and a shop as the destination of the gift. After that, a menu is displayed on the mobile terminal 46. For example, when wine is to be delivered as a gift for “abe_oo” at the table number 3 from “tanaka_□□”, “NO” is stored in a reservation field of the user name “tanaka_□□”, “OUT” is stored in a visitor field thereof, and “3” is stored in a table number as shown in FIG. 5. Further, the settlement for the gift may be processed by a credit company relating to the mobile terminal 46 as described above. Further, upon delivering a gift, a message may be also sent along with a gift. Such instructions may be made, for example, through the mobile terminal 46.

Such gifts are to be accepted among friends, but are likely to be rejected among those who do not know each other. In order to prevent such miscommunication, a group of an individual represented by a user name may be previously registered, and the gift may be accepted among members of the group. Further, even among different groups, the gift may be accepted depending on conditions. The information on these groups, including conditions, is managed by a data table (not shown). The data table is stored, for example, in the kitchen terminal 235. When a person does not belong to a group that accepts a gift, a message above is to be input, and the message is shown to the user name “abe_oo” at the table number 3. Then, only when approval is received, the gift can be accepted.

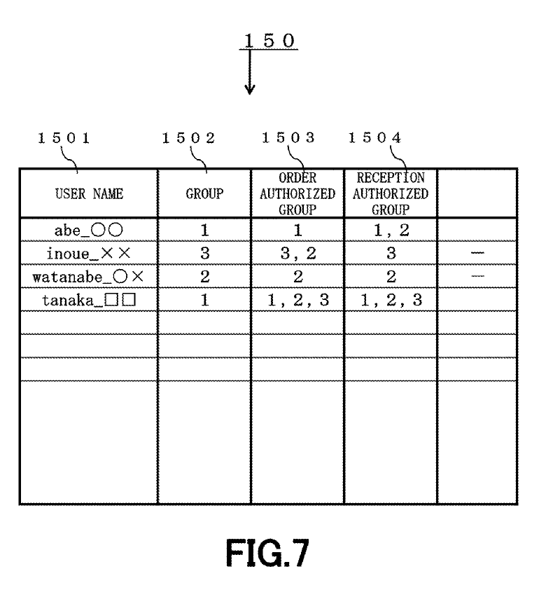

The following describes the recognition of the gift group above with reference to a gift group recognition data table 150 shown in FIG. 7. A user name field 1501 of the gift group recognition data table 150 stores therein, for example, user names such as “abe_oo”, “inoue_XX”, “watanabe_oX”, and “tanaka_□□”. The group field 1502 stores therein information indicating a group to which each user belongs, for example, a group number of each user, e.g., “1”, “3”, “2”, and “1”. When the group number is the same, the users belong to the same group. Next, the order group field 1503 stores therein, for example, “1”, “3, 2”, “2”, and “1, 2, 3”. For example, when the order group field 1503 of “inoue_XX” is “3, 2”, gifting is authorized not only for those who belong to the same group 3 but also for customers who belong to the group 2. The same applies to other users. Next, a reception authorized group field 1504 stores therein, for example, “1, 2”, “3”, “2”, and “1, 2, 3”. For example, when the reception authorized group field 1504 of “tanaka_□□” is “1, 2, 3”, the acceptance of a gift is authorized not only for those who belong to the same group 1, but also for those customers who belong to the group 2 or 3. The same applies to other users. Further, input in the gift group recognition data table 150 is made through a gift data table input screen (not shown). Further, the input screen is, for example, displayed in the output device 340 of the main system 20 or the shop system 30, and then the input is made from the input device 340 according to the display.

Further, a storage method and a storage place of the gift group recognition data table 150 is the same as the customer selection list 140.

When the series of order processes above are processed through the mobile terminal 46, for example, a biometric identification function provided to the mobile terminal 46 may be used for identity verification.

Further, though the process above is processed by the kitchen terminal 235, the process may be processed, for example, by the shop terminal 231. Further, information on reservation and gifting may be sent, for example, to the main system 20 to make a database thereof. Further, information on payment may be also included. The information on the group recognition is included and the confirmation/verification for user consent may be processed, for example, through the mobile terminal 46, or by a letter and the like.

Further, the information exchange above may be made with other management systems (not shown) via the network 10. Further, for example, order information may be gathered for each individual shop, and payment information may be managed in other management systems. Further, consent information of related people for gifting may be managed.

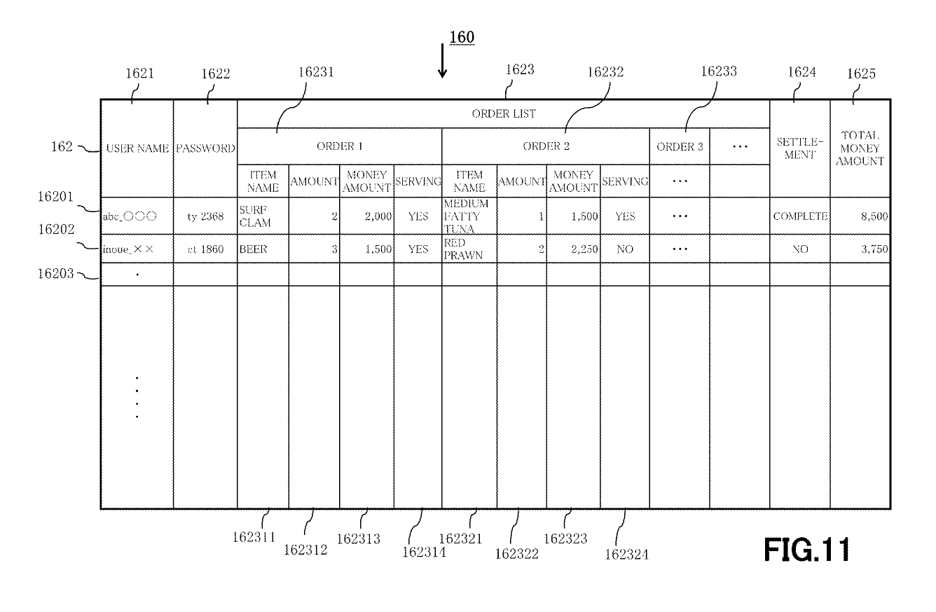

The reservation of a table and an order item is described above. The following describes details of settlement. Each order content is managed in an order list data table 160 shown in FIG. 11. The order list data table 160 includes an order list management field 162 and a user 1 order field 16201, a user 2 order field 16202, a user 3 order field 16203 etc. for managing order contents of each user. Further, the order list management field 162 includes a user name field 1621, a password field 1622, an order list field 1623, a settlement field 1624, a total money amount field 1625, and the like. The order list field 1623 further includes an order 1 field 16231, an order 2 field 16232, an order 3 field 16233 etc. Each order field includes item name fields 162311,162321, 162331 etc., amount fields 162312, 162322, 162332 etc., money amount fields 162313, 162323, 162333 etc., and serving fields 162314, 162324, 162334 etc.

A storage method and a storage place of the order list data table 160 is the same as the customer selection list 140 and the gift group recognition data table 150.

For example, the following describes a method of managing an order content of the user name “abc_ooo” and “ty_{—}2368” in the user 1 order field 16201. When the user name “abc_ooo” orders, for example, two plates of “Surf Clam”, information “Surf Clam” is stored in the item name field 162311 of the user 1 order field 16201, and “2” is stored in the amount field 162312. Further, when the price for the surf clam is 1,000 Yen per plate, “2000” is stored in the money amount field 162313 of the user 1 order field 16201. Further, when the ordered surf clam is served, “DONE” is stored in the serving field 162314. Further, when there is additionally an order 2, each information is stored in the order 2 field 16232 in the same manner as the order 1 field 16231. The sum of the money amount of these orders is stored in the corresponding total money amount field 1625. Thus, for example, the order relating to the user 1, including the items reserved prior to the visit, is managed in the user 1 order field 16201.

Further, the following describes the settlement for the user 1. For example, when an input indicating that the customer intends to settle the payment is made according to the display screen (not shown) through the ordering terminal 233 and the mobile terminal 46, the processor 310 of the kitchen terminal 235 checks whether serving on orders are complete and whether the total money amount is correct, for example, according to the program loaded in the memory 320 of the kitchen terminal 235. When it is determined that the settlement can be made, information “COMPLETE” is stored in the settlement field 1624 of the user 1 order field 16201.

When the settlement is complete as described above, information “NO” is stored in the reservation field 1404 and the visitor field 1405 in FIG. 5, and a configuration is set in a manner such that the additional following order from the corresponding customer is not to be accepted. Further, a settlement money amount “8,500” of a user name “abc_ooo” and “ty_{—}2368” is sent to the POS system 232 via the in-shop network 237 and the shop terminal 231. The POS system 232 stores this information in the POS memory 2322 via the POS interface 2325. This process is processed, for example, by the POS processor 2321 with a program loaded in the POS memory 2322.

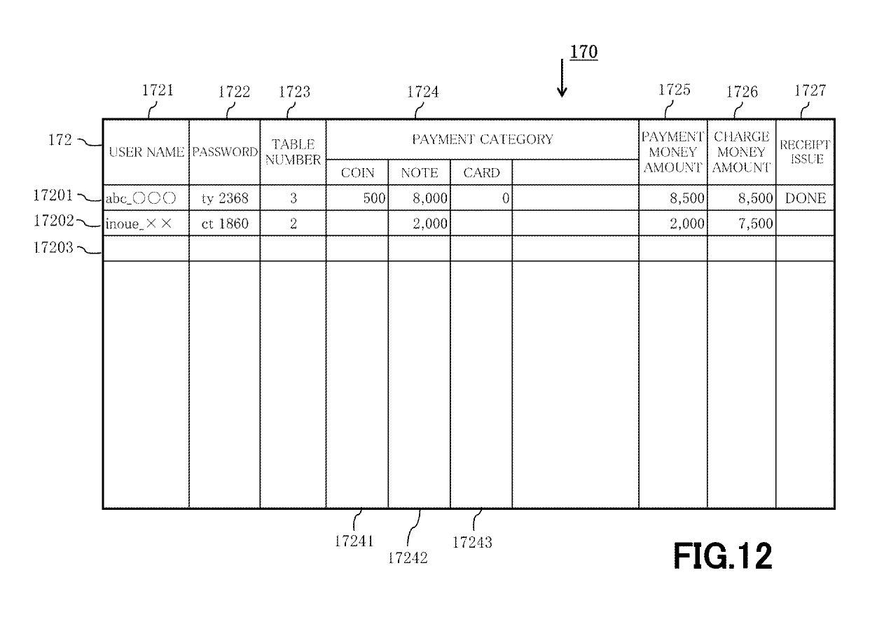

In the POS system 232, settlement information is managed by a settlement list data table 170 shown in FIG. 12. The settlement list data table 170 includes a settlement list management field 172, and a user 1 settlement field 17201, a user 2 settlement field 17202, a user 3 settlement field 17203 etc. for managing a settlement content of each user. Further, the settlement list management field 172 includes a user name field 1721, a password field 1722, a table number field 1723, a payment category field 1724, a payment money amount field 1725, a charge money amount field 1726, and a receipt issue field 1727. Further, the payment category field 1724 includes a coin field 17241, a note field 17242, a card field 17243 etc.

In the settlement list data table 170 for the user 1 settlement field 17201 of the user name “abc_ooo”, “abc_ooo” is stored in the user name field 1721, “ty_{—}2368” is stored in the password field 1722, “3” is stored in the table number field 1723, “8,500” is stored in the charge money amount field 1726. These processes are processed, for example, by the POS processor 2321 according to a program loaded in the POS system 232. Further, each information is stored based on the information from the customer selection list 140 and the order list data table 160. As for the table number, identification information such as an IP address of the ordering terminal provided at the table may be associated with unique information of the table according to an association data table (not shown), and then the number may be managed using the IP address.

When the settlement is ready and the customer whose user name is “abc_ooo” is taken to the place having the POS system 232, table numbers where the settlement is ready are displayed (not shown) by the POS processor 2321 on the POS display device 291 via the POS output unit 2323, the POS output controller 23231, and the POS information output unit 23236. Then the customer selects his/her table number, for example, “3” out of these table numbers displayed on the screen. When the table “3” is selected, it is determined that the settlement is for “abc_ooo” corresponding to “3” in the table number field 1723, and then the user name “abc_ooo” is displayed (not shown) on the POS display device 291, and the customer is asked for an input of a password. The customer input information on a password is sent from the POS input device 292 to the POS processor 2321 via the POS information input unit 23246, the POS input controller 23241, and the POS input unit 2424. If the password matches with the information in the corresponding password field 1722, the payment process for the settlement is started.

The settlement is, for example, available by payment means such as a card payment that allows deferred payment based on customer's credit and cash payment with coins and notes. These payment means are displayed (not shown) on the POS display device 291 for the selection by the customer. When the customer follows the instructions on the screen and selects the payment means, for example, the cash payment with coins and notes, the coin processing device 293 and the note processing device 294 opens a coin insertion slot and a note insertion slot (not shown) so as to accept insertion of coins and notes via the POS output unit 2323, the POS output controller 23231, a coin processing output unit 13232, a note processing output unit 13233. At this process, the acceptance may be displayed with a lamp or the like.

For example, the customer inserts a 500 yen coin as the insertion slot of the coin processing device 293 is open, and the 500 yen is recognized by the coin processing device 293. Then, this information is sent to the POS processor 2321 via the coin processing input unit 23242, the POS input controller 23241, and the POS input unit 2324. Based on this information, the POS processor 2321 stores information “500” in the coin field 17241 of the user 1 settlement field 17201. Similarly, when eight 1,000 bills are inserted into the note insertion slot, the POS processor 2321 stores information “8,000” in the note field 17242 based on this information. At this point, the sum of the money amount stored in each field of the payment category field 1724 is stored in the payment money amount field 1725. If the amount matches with the charge money amount field 1726, it is determined that the payment is complete.

In other cases, when no coin is inserted and one 10,000 yen bill is inserted into the note insertion slot (not shown) of the note processing device 294 in the case described above, one 500 yen coin may be ejected from a coin ejection slot (not shown) and one 1,000 yen bill may be ejected from a note ejection slot (not shown), respectively. In other cases, when one 500 yen coin is inserted and then one 10,000 yen bill is inserted, two 1,000 yen bills may be ejected.

Further, when the card payment is selected, a card insertion/ejection slot (not shown) of the card processing device 296 is opened so as to enable the insertion of a card, and then the process is performed in the same manner as those with coins and notes. At this point, if the card payment money amount is not sufficient for the charge money amount, additional payment with coins and notes may be available. Further, instead of a card, a payment function provided with the mobile terminal 46 may be used. Further, the process may be performed according to a password that is set on the mobile terminal side. As described above, the payment is performed through combination of payment with credit and payment with cash, for example, yen.

Further, the settlement may be performed with points that are exclusively set by a shop, a corporation, or an industry association. In this case, similarly to cash and a card, a category for such settlement is added to the payment category field 1724 to be managed. Further, the settlement may be performed with virtual currency and the like.

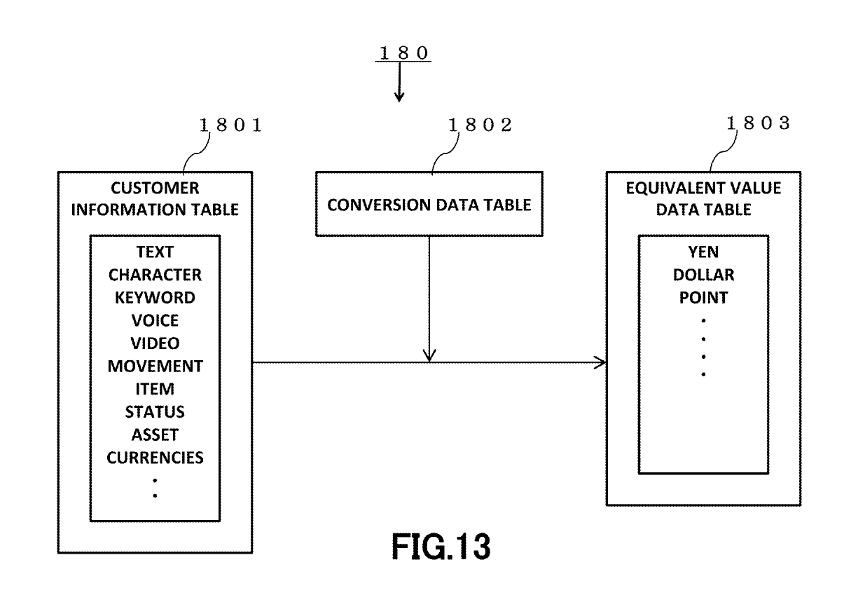

Further, settlement may be performed based on an additional category where the various kinds of information are converted into a money amount based on a value decision standard that is independently set by a shop or a corporation and the category for the settlement is added to the payment category field 1724. The following describes this conversion to the money amount with reference to an information value conversion schematic diagram 180 shown in FIG. 13. The information value conversion schematic diagram 180 includes a customer information table 1801 for storing therein various kinds of information on customer's payment prior to the value conversion, a conversion data table 1802 for storing therein information for converting the various kinds of information on payment into money value, and an equivalent value data table 1803 for storing therein a money amount that is converted into currency value. Each table is loaded in the POS memory 2322 of the POS system 232 and processed by the POS processor 2321 according to a program loaded in the POS memory 2322. However, this process may be processed by other systems such as the shop system 30, main system 20, and the cloud 42 instead of the POS system 232. Customer information gathered through the POS display device 291, for example, customer's currency that is not usually exchanged in city banks or account information having equivalent values, is input in the customer information table 1801. When an instruction is made indicating that the settlement is to be made with this, the amount is converted at last to the money amount with, for example, yen based on a conversion ratio, remaining balance, and information for determining whether the settlement is possible, which are stored in the conversion data table 1802, and the result thereof is stored in the equivalent value data table 1803. Further, when there is no information on this account in the conversion data table 1802, information for determining whether the settlement is possible may be obtained via the POS interface 2325, the in-shop network 237, and the network 10 and then may be stored in the conversion data table 1802. Further, when needed, conversion money amount into other currency instead of yen, for example, dollar, may be stored in the equivalent value data table 1803.

Such equivalent value conversion is not limited to currencies that are not usually exchanged in city banks, and can be based on information that is usually not evaluated as conversion value such as customer's assets, status, character, keyword, voice, image, movement, owned property etc. Based on the corporation's own standard, such information may be examined so as to determine whether it is sufficient to settlement money amount. For example, customer's asset information is stored in the customer information table 1801 in the same way as the currency that is usually not exchanged. Based on this information, an equivalent value money amount is calculated according to the conversion data table 1802 and then is stored in the equivalent value data table 1803.

Instead of the asset, for example, an image of customer's face or a body is captured by the POS display device 291, and when the customer is a celebrity, the popularity may be deemed as a source asset for settlement. In other cases, whether or not the customer is famous or not, when information of use for the store is input, e.g., the customer's own text, poem, lyrics, singing, characters etc., such information may be determined as the customer's assets and may be deemed as a source asset. In other cases, when a consent is made that the order content of a customer is used as a keyword, the information value of such a keyword may be deemed as a source asset. A customer's talk, voice, or singing voice may be deemed as a source asset in the same manner. Further, customer's movement such as dance may be deemed as a source asset in the same manner. Information on the customer's own items and pets may be deemed as a source asset. Further, the information content broadcasted by the customer may be deemed as a source asset in the same manner. Further, when it is determined as valuable that the customer evaluates certain information so as to determine whether it is “GOOD” or “BAD”, such evaluation may be deemed as a source asset in the same manner. Further, when a connection content to a community system facilitating inter-human connections, e.g., a social network system (referred to as SNS) is determined as valuable, such contents may be deemed as a source asset in the same manner. Other than that, when information owned by a customer is determined as valuable, such information may be deemed as a source asset in the same manner. Further, the settlement is made based on the conversion money amount stored in the equivalent value data table 1803.

After the settlement is complete through various kinds of payment means as described above, the POS processor 2321 may send information that is necessary at last to the ticketing processing device 295 so as to issue a receipt. In other cases, when the payment is made through means relating to the card or the mobile terminal 46, such information may be written into a card or may be sent to the mobile terminal 46.

Though the process for the payment after having a meal, that is, a deferred payment is described above, the following describes a process for advance payment. After a customer orders a surf clam following the display (not shown) on the POS display device 291 and completes the payment in the same manner above, the ticketing processing device 295 issues a food ticket. At this time, a table number is simultaneously printed so as to guide the customer to the table.

Even when reservation is made through the mobile terminal 46 from the outside of the shop before the order of the surf clam, the food ticket is issued in the same manner upon the completion of the payment. Further, instead of issuing a food ticket, for example, the information indicating the completion of payment may be sent to the mobile terminal 46. Then, information exchange is made between the ordering terminal 233 and the mobile terminal 46 according to the specified table so as to confirm that the customer is seated at the table, and the ordered item may be served after the confirmation. As described above, a process can be performed through advance payment with use of the customer selection list 140, the order list data table 160, the settlement list data table 170 and the like.

In the embodiments above, the embodiments of the present invention are described with applications of functions provided by controlling programs of computers and processors. However, the embodiments of the present invention are not limited to controlling of programs of computers and processors, and may be realized with other elements or aggregate of elements. Further, for example, a part of or entire means made available with computers and processors may be performed through manual labor or the like.

As described above, an order from a customer can be realized by pushing down a menu displayed in the ordering terminal or by operating the mobile terminal 46.

Further, services such as gifting can be realized through the mobile terminal 46. Further, as for services other than gifting, various kinds of goods, including information, may be delivered to an inside of a shop without actually visiting the shop.

Further, settlement can be made through various kinds of payment means.

### INDUSTRIAL APPLICABILITY

The present invention relates to industries with shops, including restaurant business, and is effective for simplifying and facilitating tasks pertaining to orders at shops. Further, the customer can place an order through the mobile terminal 46, which leads to improvement in customer satisfaction. Further, various kinds of payment means lead to improvement in convenience.

Further, the system of the present invention is not limited to the ordering in restaurant business. For example, the system is applicable for ordering of a desired product in general retail industry or gathering desired order item from an inventory rack in distribution industry. Therefore, the present invention is applicable in restaurant business and further in various fields of industries such as tourism industry and general industry.

### REFERENCE SIGNS LIST

10 NETWORK
20 MAIN SYSTEM
30 SHOP SYSTEM
40 DATA SITE
42 CLOUD
44 MANAGEMENT SYSTEM
46 MOBILE TERMINAL
120 MENU SCREEN
140 CUSTOMER SELECTION LIST
160 ORDER LIST DATA TABLE
170 SETTLEMENT LIST DATA TABLE
180 INFORMATION VALUE CONVERSION SCHEMATIC DIAGRAM
231 SHOP TERMINAL
232 POS SYSTEM
233 ORDERING TERMINAL
234 STAFF TERMINAL
235 KITCHEN TERMINAL
236 ORDER RECEPTION/GENERATION SYSTEM
291 POS DISPLAY DEVICE
292 POS INPUT DEVICE
293 COIN PROCESSING DEVICE
294 NOTE PROCESSING DEVICE
295 TICKETING PROCESSING DEVICE
296 CARD PROCESSING DEVICE
310 PROCESSOR
320 MEMORY
330 OUTPUT DEVICE
340 INPUT DEVICE

1. A shop system that can be connected with a main system via wired or wireless communication, comprising:
settlement means for processing settlement at the shop system by cash or equivalent values;
deferred credit payment means; and
adding means for adding up the money amount of the settlement means and the money amount of the deferred credit payment means.

2. The shop system according to claim 1, further comprising:
means for enabling advance payment as a method of payment.

3. The shop system according to claim 1, further comprising:
means for converting values pertaining to information owned by a customer into a source asset for settlement.

4. The shop system according to claim 1, further comprising:
means for directly sending and receiving information pertaining to orders from a terminal different from each terminal included in the main system and the shop system to the terminal included in the main system and the shop system.

5. The shop system according to claim 1, further comprising:
means for processing information for determining whether an order is accepted based on a rank of a customer.

6. The shop system according to claim 1, further comprising:
means for directly ordering and processing payment without a visit at a shop.

7. The shop system according to claim 1, further comprising:
means for processing authorization and un-authorization of an order pertaining to a group to which a customer directly ordering without a visit at the shop belongs and a group to which a customer receiving an order belongs.

8. A program and a storage medium for a shop system that can be connected with a main system via wired or wireless communication, comprising functions, with a processor, to control:
settlement means for processing settlement at the shop system by cash or equivalent values;
deferred credit payment means; and
adding means for adding up the money amount of the settlement means and the money amount of the deferred credit payment means.

9. The program and the storage medium for the shop system according to claim 8, comprising functions, with a processor, to control:
means for enabling advance payment as a method of payment.

10. The program and the storage medium for the shop system according to claim 8, further comprising functions, with a processor, to control:
means for converting values pertaining to information owned by a customer into a source asset for settlement.

11. The program and the storage medium for the shop system according to claim 8, comprising functions, with a processor, to control:
means for directly sending and receiving information pertaining to orders from a terminal different from each terminal included in the main system and the shop system to the terminal included in the main system and the shop system.

12. The program and the storage medium for the shop system according to claim 8, further comprising functions, with a processor, to control:
means for processing information for determining whether an order is accepted based on a rank of a customer.

13. The program and the storage medium for the shop system according to claim 8, further comprising functions, with a processor, to control:
means for directly ordering and processing payment without a visit at a shop.

14. The program and the storage medium for the shop system according to claim 8, further comprising functions, with a processor, to control:
means for processing authorization and un-authorization of an order pertaining to a group to which a customer directly ordering without a visit at the shop belongs and a group to which a customer receiving an order belongs.

15. A control method for a shop system that can be connected with a main system via wired or wireless communication, comprising:
a settlement step of processing settlement at the shop system by cash or equivalent values;
a deferred credit payment step; and
an adding step of adding up the money amount of the settlement step and the money amount of the deferred credit payment step.

16. The control method for the shop system according to claim 15, further comprising:
a step of enabling advance payment as a method of payment.

17. The control method for the shop system according to claim 15, further comprising:
a step of converting values pertaining to information owned by a customer into a source asset for settlement.

18. The control method for the shop system according to claim 15, further comprising:
a step of directly sending and receiving information pertaining to orders from a terminal different from each terminal included in the main system and the shop system to the terminal included in the main system and the shop system.

19. The control method for the shop system according to claim 15, further comprising:
a step of processing information for determining whether an order is accepted based on a rank of a customer.

20. The control method for the shop system according to claim 15, further comprising:
a step of directly ordering and processing payment without a visit at a shop.
